(19) United States
(12) Patent Application Publication
(10) Pub. No.: US 2011/0283508 A1
(43) Pub. Date: Nov. 24, 2011

(54) Apparatus for fixedly locating a first aerospace component relative to a second aerospace component

(75) Inventor: Simon John Parker, Bristol (GB)

(73) Assignee: AIRBUS OPERATIONS LIMITED, Bristol (GB)

(21) Appl. No.: 13/067,209

(22) Filed: May 17, 2011

(30) Foreign Application Priority Data
May 17, 2010 (GB) 1008182.6

(51) Int. Cl. B23P 11/00; B23P 19/00

(52) U.S. Cl. 29/428; 29/700

(57) ABSTRACT

An apparatus for fixedly locating a first aerospace component relative to a second aerospace component comprising a housing mountable on a first component with a cylinder formed in said housing, and a piston slidably received in said cylinder, wherein a first end of the piston is extendible from the housing such that, when a hardenable hydraulic fluid is injected into the cylinder to act on a second end of said piston, said first end of the piston is urged to slide away from the housing and into abutment with a second component to locate said second component, and said second component is fixedly located in a desired position relative to said first component when the hydraulic fluid hardens.

### INTRODUCTION

The present invention relates to an apparatus for fixedly locating aerospace components relative to each other. Particularly, but not exclusively, the invention relates to an apparatus for driving, clamping, locking or shimming an aerospace component relative to another aerospace component.

### BACKGROUND

Aircraft are assembled from a number of separate assemblies which are then fixedly mounted to each other during assembly of the aircraft. Such an assembly includes wing boxes, leading and trailing edges of a wing, horizontal tail planes (HTPs), Vertical Tail Planes (VTPs) and the fuselage, which are themselves formed from a number of discrete components including spars, ribs, skin, gunnels, compression struts, and stringers.

Such components and subassemblies are fixedly located relative to each other using conventional mechanical fixings, such as bolts and rivets. Although such conventional fixings form a secure joint to fixedly locate adjacent surfaces, they are known to have a number of disadvantages when used in an aerospace assembly.

Conventional mechanical fixings, such as bolts or rivets, require pre-formed holes extending through a section of each component to be fixedly located. However, such pre-formed holes are known to cause localised stress concentrations in the components proximal to the hole, which may lead to a structural failure of the joint and components, and cause, for example, fuel leakage or overall breakdown of the aircraft. In an attempt to address the problems referred to above, it is known to employ an adhesive or the like to fix the components together and so replace conventional fixings, as a joint formed by an adhesive does not necessitate holes formed through the components to be joined. However, a problem with using adhesive is that the components are liable to peel apart and the joint to fail without warning. Furthermore, in order to fixedly locate surfaces of respective components, it is necessary for the surfaces to be formed to exact tolerances and carefully aligned. It is not possible to use such a fixing to draw components towards each other, or urge a component towards, away from or against another component using such a fixing.

Components of aircraft assemblies and sub-assemblies are generally formed from a metallic material, such as an aluminium sheet, a moulding or an extrusion. However, there has been a move within the aerospace industry towards the use of carbon fibre materials which have certain weight, strength and fatigue advantages over their metallic counterparts. It is important for such components to be formed to exact tolerances and to be mounted and located with respect to each other to close tolerances. Carbon fibre composite material components are generally formed by an open moulded forming process, however, an issue with such components is that, although one surface is generally produced to an exact tolerance, the opposing surface is generally of low tolerance, typically up to +/−4%. With conventional fixings it is not possible for these inevitable manufacturing tolerances to be taken up during assembly, and so it is necessary to modify or shim components to obtain the exact tolerances needed to ensure the desired joint. It is a time consuming process to measure and modify components to account for these manufacturing issues, which can often occur in many locations in different planes.

With conventional low volume aircraft manufacture processes there is the opportunity to modify or shim components to obtain the exact tolerances needed. However, there has been a move towards high speed automated assembly processes for high volume manufacture throughout the aerospace industry, and so the need to produce components with a tight manufacturing tolerance runs contrary to this high speed assembly and may lead to a large amount of wastage and scrap due to components not meeting the required tolerances. It is therefore desirable to provide an apparatus which allows for the inevitable manufacturing misalignments generated from manufacturing tolerances to be taken up.

Furthermore, mechanical fixings formed from a metallic material may pose a problem to aircraft formed from carbon fibre composite components, as they may provide an electrical conduit. Therefore, such fixings may cause electrical failure or ignition of the fuel held in the fuel tank when an aircraft is struck by lightening.

The present invention therefore seeks to provide an apparatus for fixedly locating aerospace components relative to each other which substantially overcomes or alleviates the known problems with conventional fixings described above.

### SUMMARY OF THE INVENTION

According to the invention, there is provided an apparatus for fixedly locating a first aerospace component relative to a second aerospace component comprising a housing mountable on a first component with a cylinder formed in said housing, and a piston slidably received in said cylinder, wherein a first end of the piston is extendible from the housing such that, when a hardenable hydraulic fluid is injected into the cylinder to act on a second end of said piston, said first end of the piston is urged to slide away from the housing and into abutment with a second component to locate said second component, and said second component is fixedly located in a desired position relative to said first component when the hydraulic fluid hardens.

Preferably, a plurality of cylinders are formed in the housing and each cylinder slidably receives a piston therein.

In one embodiment, the plurality of pistons are configured to slide in the same direction from the housing along parallel longitudinal axes.

In another embodiment, at least one piston is configured to slide from the housing along a longitudinal axis extending at an incline to another piston.

In a further embodiment, at least one piston is configured to slide from the housing along a longitudinal axis extending transversely to another piston.

Conveniently, a manifold fluidly connects each of the plurality of cylinders to each other, such that the same hydraulic pressure is applied in each cylinder, to each piston.

The apparatus may further comprise a fluid inlet formed in the housing which is in fluid communication with the manifold, so that a fluid is injected into each cylinder when said fluid is injected through the inlet.

A seal may circumferentially extend around the piston which seals against the sidewall of the cylinder, and the seal is preferably a double acting seal.

Advantageously, the piston is a primary piston which is slidably received in the cylinder which is a primary cylinder, and the apparatus may further comprise a secondary cylinder formed in said first end of the primary piston and a secondary piston which is slidably received in the secondary cylinder to extend from said first end.

Preferably, a cavity is defined between the secondary cylinder and the secondary piston to receive a resin or adhesive and a passageway may extend from the cavity to said first end of the primary piston, such that when the secondary piston is urged to slide into the secondary cylinder, the resin or adhesive is urged to flow to said first end of the primary cylinder.

Advantageously, the passageway is a gulley formed in a side wall of the secondary cylinder.

Conveniently, a plurality of longitudinally extending gullies are formed in the side wall of the secondary cylinder.

In one embodiment, a shear resisting means is formed in the piston to receive a hydraulic fluid injected into the cylinder, such that when the hydraulic fluid hardens into a solid state, the piston is restricted from shearing relative to said hydraulic fluid hardened into a solid state.

Preferably, a hollow is formed in the second end of the piston and the shear resisting means is formed in a side wall of the hollow.

Conveniently, the shear resisting means comprises a circumferentially extending groove formed in the side wall of the hollow.

Advantageously, a shear resisting means is formed in the side wall of the cylinder to receive a hydraulic fluid injected into the cylinder, such that when the hydraulic fluid hardens into a solid state, the hydraulic fluid hardened into a solid state is restricted from shearing relative to the housing.

Preferably, the shear resisting means comprises a circumferentially extending groove formed in the side wall of the cylinder.

In a preferred embodiment the apparatus further comprises a hydraulic fluid which is injected into the cylinder to act on the second end of the piston slidably received in said cylinder and urge a first end of said piston is urged to slide away from the housing.

Conveniently, the fluid is configured to harden in the cylinder such that the piston is restricted from sliding back into the cylinder.

Advantageously, the fluid is a curable resin.

Preferably, reinforcing materials are suspended in the curable resin.

In one embodiment, the first end of the piston is formed from uncured carbon fibre and is configured to be penetrated by a mating means extending from said second component to fixedly mount said first end of the piston to said second component.

According to another aspect of the invention, there is provided a joint comprising a first component and a second component which are fixedly located to each other by an apparatus.

Preferably, the joint further comprises a mating means extending from said second first component, and penetrating into the first end of the second component.

According to another aspect of the invention, there is provided a method of fixedly locating a first aerospace component relative to a second aerospace component with an apparatus comprising a housing with a cylinder formed in said housing, and a piston slidably received in said cylinder, wherein a first end of the piston is extendible from the housing, the method including the steps of mourning the housing to a first component, injecting a hardenable hydraulic fluid into the cylinder to act on a second end of the piston disposed in said cylinder, such that said first end of said piston is urged to slide away from the housing and into abutment with a second component to locate said second component, and hardening said hydraulic fluid such that said second component is fixedly located in a desired position relative to said first component.

Preferably, the hardenable hydraulic fluid is a curable resin, and the method may further include the steps of removably mounting a heating means to the housing and operating said heating means to heat and cure the resin.

According to another aspect of the invention, there is provided an assembly of components prepared by the method of fixedly locating a first aerospace component relative to a second aerospace component, the method including the steps of mounting an apparatus comprising a housing with a cylinder formed in said housing and a piston slidably received in said cylinder, to a first component, locating said first component relative to a second component, injecting a hardenable hydraulic fluid into the cylinder to act on a second end of the piston disposed in said cylinder, such that a first end of said piston is urged to slide away from the housing to abut against and locate said second component, and hardening the hydraulic fluid such that said second component is fixedly located in a desired position relative to said first component.

### BRIEF DESCRIPTION OF THE DRAWINGS

Embodiments of the invention will now be described, by way of example only, and with reference to the accompanying drawings, in which:

FIG. 1 is a perspective view of a cylinder array according to one aspect of the invention showing a plurality of pistons in a retracted position in their respective cylinders;

FIG. 2 is an illustrative cross-sectional view of the cylinder array shown in FIG. 1 showing the pistons in a partially expanded position;

FIG. 3 is an illustrative exploded cross-sectional view of the cylinder array shown in FIG. 2;

FIG. 4 is an illustrative cross-sectional side view of a cylinder and piston shown in FIG. 1 showing a shear restricting structure;

FIG. 5 is an illustrative front view of the cylinder array shown in FIG. 3 showing the piston in a retracted position;

FIG. 6 is an illustrative cross-sectional view of the cylinder array shown in FIG. 5 showing the piston in a retracted position;

FIG. 7 is an illustrative front view of the cylinder array shown in FIG. 3 showing the piston in an expanded position;

FIG. 8 is an illustrative cross-sectional view of the cylinder array shown in FIG. 7 showing the piston in an expanded position;

FIG. 9 is an illustrative cross-sectional view of a mating means for fixedly mounting the cylinder array shown in FIG. 1 to a component;

FIG. 10 is an illustrative cross-sectional view of an alternative mating means for fixedly mounting the cylinder array shown in FIG. 1 to a component; and

FIG. 11 is an illustrative cross-sectional view of a number of alternative projection profiles of the mating means shown in FIGS. 9 and 10.

### DESCRIPTION OF THE PREFERRED EMBODIMENTS

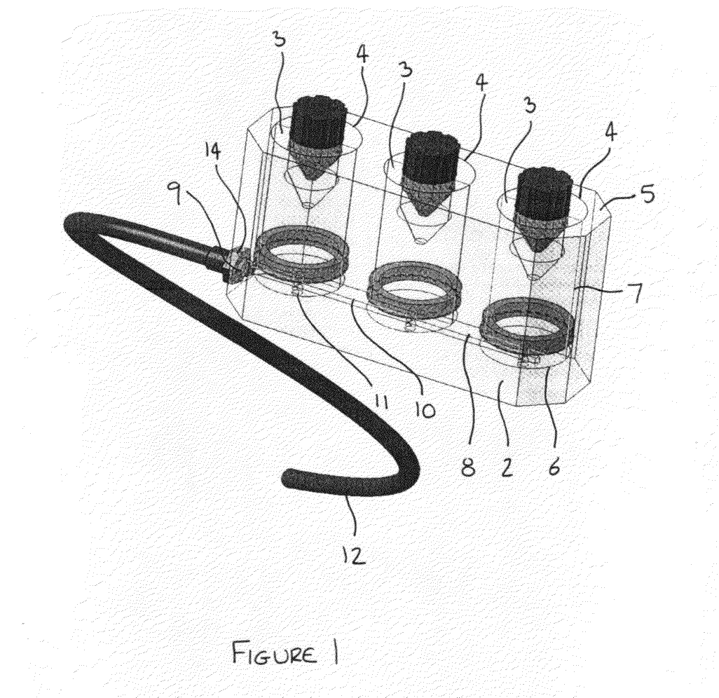

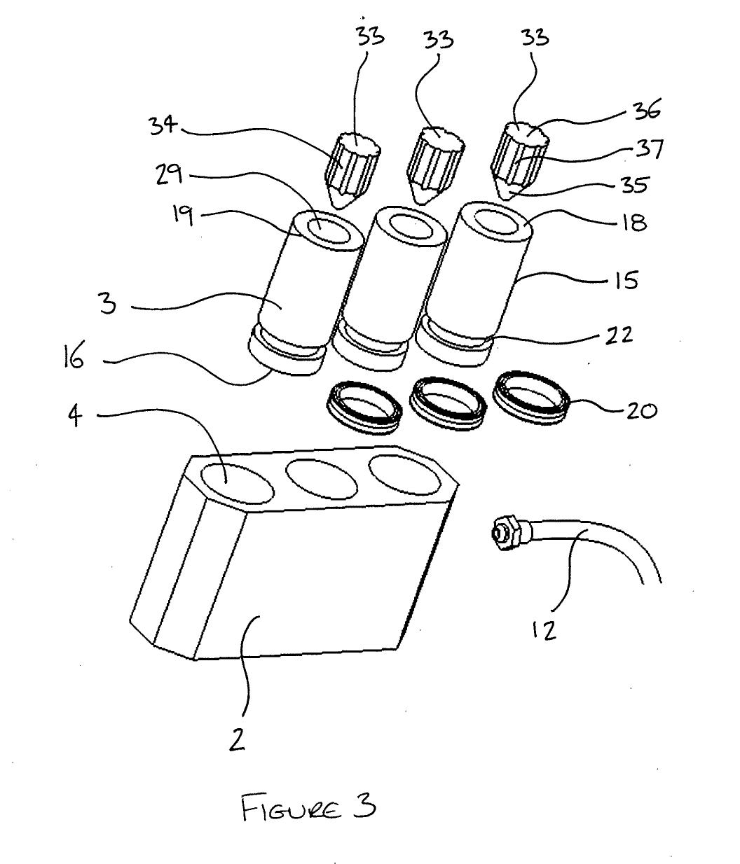

Referring now to the drawings, a cylinder array 1 is shown in FIGS. 1 to 3 comprising a main housing 2 with three cylinders 4 formed therein, and a piston 3 disposed in each of said cylinders 4. Each cylinder 4 is a cylindrical bore extending into the housing 2 from a top face 5 of said housing 2, and each cylinder 4 comprises a base 6 and a side wall 7 extending circumferentially therearound. Although in the present embodiment the cylinders 4 extend into the housing 2 from the top face 5, it is envisaged that in an alternative embodiment cylinders extend into the housing from different faces of the housing 2, so that pistons 3 disposed therein extend in different directions, as will become apparent hereinafter.

A manifold 8 is formed in the main housing 2 and extends from an inlet 9. The manifold 8 fluidly connects the inlet 9 to each cylinder 4, and comprises a passageway 10 extending from the inlet 9 through a lower portion of the main housing 2 below the cylinders 4, and a plurality of orifices 11 extend from the passageway 10 to communicate with each cylinder 4. Each orifice 11 extends transversely from the passageway 10 and forms an aperture in the centre of the base 6 of each cylinder 4 so that each cylinder 4 communicates with the manifold 8. An inlet pipe 12 is threadingly engaged with the inlet 9 by a threaded section 14, and the inlet pipe 12 and manifold 8 are configured to supply a fluid into each cylinder 4 to hydraulically activate each piston 3 disposed therein from an initial, retracted position, wherein each piston 3 is recessed in its respective cylinder 4, and an expanded position, wherein each piston 3 extends from its respective cylinder 4.

It is envisaged that, in the following exemplary embodiments, the fluid is settable to form a solid once the pistons 3 have been urged into their expanded position, as will become apparent hereinafter. In such a case, the fluid is a resin which is initially injected into the manifold 8 as a liquid to hydraulically activate each piston 3, but which subsequently cures into a solid state to set each piston 3 in said expanded position, and prevents the pistons 3 from sliding back into their respective cylinder 4, as will be described below. Although in the following exemplary embodiments an uncured resin is used, it will be appreciated that the fluid is not limited thereto and that the substance may be any material which can be injected into the manifold 8 to act as an hydraulic fluid and which subsequently is in a solid state to maintain each piston 3 in its expanded position. In another embodiment, the fluid is a resin with reinforcing materials, such as finely chopped fibres or nano-particles, suspended in it, in order to prevent the breakup and dusting of the resin once it has cured and is subjected to movement, such as vibration.

The main housing 2 is formed from a lightweight plastic material, and is formed by moulding, for example resin transfer moulding, and/or machining. Alternatively, the main housing 2 may be formed from a metallic or composite material into which the cylinders and/or manifold are machined.

Mounting points (not shown) are formed in the main housing 2 to enable the main housing to be mounted to a first component (not shown) which is to be located and/or mounted relative to a second component (not shown). Although in the present embodiment the cylinder array 1 is a discrete component which is mounted to the first component such that the second component may be located and/or fixed relative thereto, for example by fixing, driving, clamping, locking or shimming, it will be appreciated that the main housing 2 may be integrally formed with said first component.

A valve (not shown) is disposed in the fluid pathway supplying a resin to the inlet 9 to control the flow of the resin in a fluid state into the manifold 8 and hence each cylinder 4. The valve is a Schrader valve, a manual open and close configuration valve, or a self bleed type valve.

Each cylinder 4 formed in the main housing 2 slidably receives one of the pistons 3. Each piston 3 is cylindrical with a piston side wall 15 and a piston base 16. The side wall 15 of each piston 3 forms a close fit in its respective cylinder 4 is slidable therein in a longitudinal direction along a central axis of the respective cylinder 4. A chamber 17 is formed in each cylinder 4 when its respective piston 3 is received therein and is defined between the opposing surfaces of the cylinder base 6 and the opposing piston base 16, and the cylinder side wall 7 extending therearound. The chamber 17 of each cylinder 4 is configured to receive the uncured resin acting as a hydraulic fluid; and the inlet 9, manifold 8 and plurality of chambers 17 form a hydraulic system in fluid communication with each other to urge each piston 3 out of, or into and out of, their respective cylinders 4, as will become apparent hereinafter. A cylindrical hollow 16a is formed in each piston base 16, extending into the piston 3, into which resin flows when resin is injected into each chamber 17.

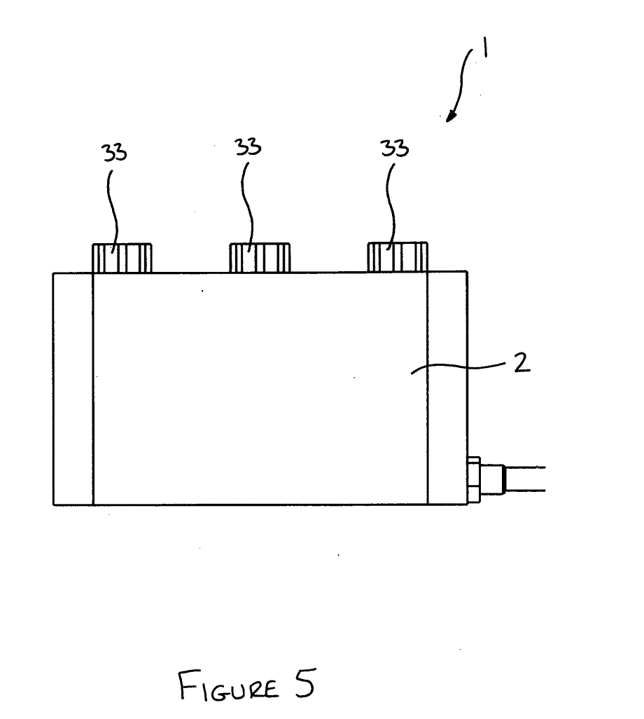

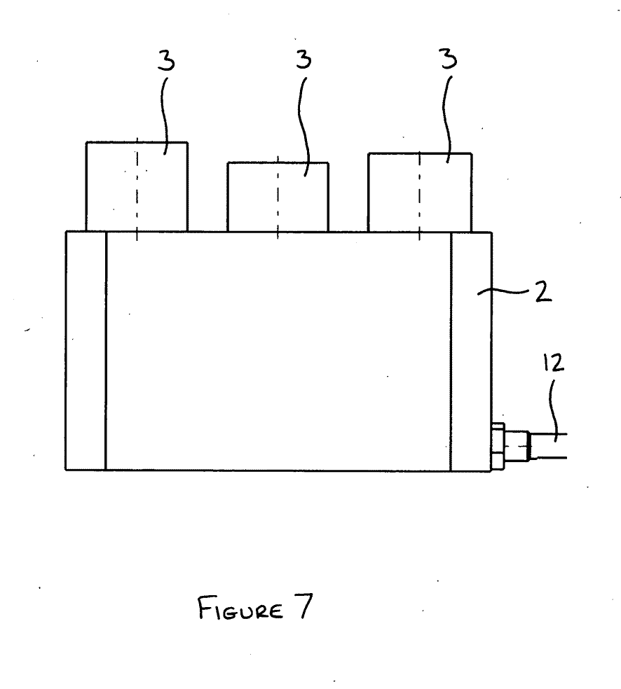

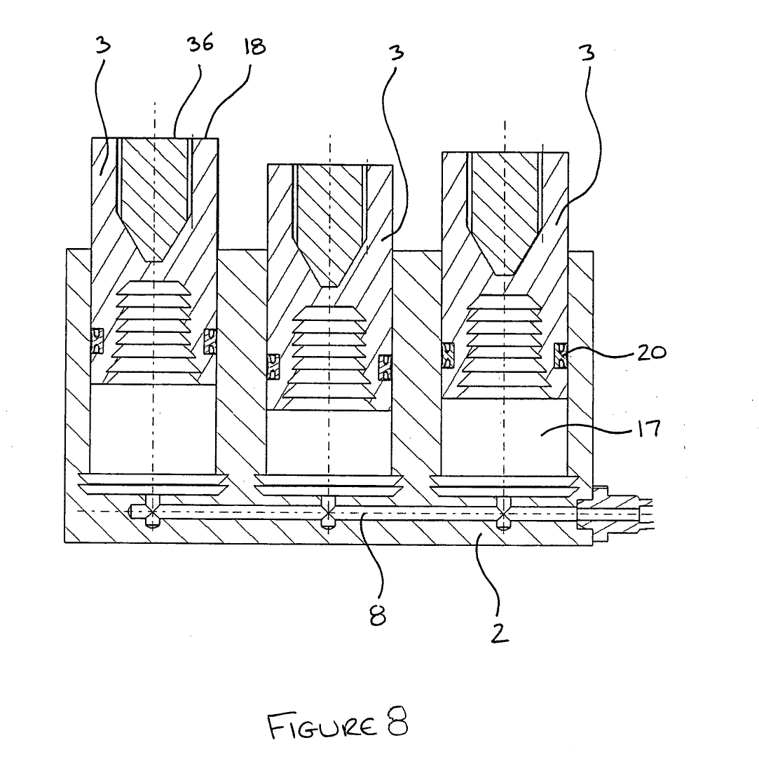

Each piston 3 has an upper face 18 formed at an upper end 19 thereof which is distal to the piston base 16. The upper face 18 is arranged as a surface to abut against and/or mate with an opposing surface of the corresponding second component, as will become apparent below. In the present embodiment, the length of each piston 3 is equal to the depth of its respective cylinder 4 so that, in an initial, retracted position, the upper face 18 of each piston 3 is level with the top face 5 of the housing 2 (as shown in FIG. 5), and in an expanded position, the upper end 19 of each piston 3 extends from its respective cylinder 4 (as shown in FIGS. 7 and 8). However, it will be understood that in an alternative embodiment, the length of each piston 3 is longer than the depth of the cylinder 3 in which it is received so that the upper end 19 of each piston 3 always extends from its respective cylinder 4 and does not recess below the top face 5 of the housing 2.

It will be appreciated that the length of each piston does not affect the pressure that the surface of the upper face 18 exerts on an opposing surface of the corresponding second component and so, although each piston 3 is shown to be of equal length, it will be understood that the pistons 3 may have differing lengths dependent on the arrangement of the an opposing surface of a corresponding second component, against which the upper face 18 of each piston 3 is arranged to abut and/or mate with.

A seal 20 extends circumferentially around the side wall 15 of each piston 3. The seal 20 is a double acting seal; that is a seal which is capable of resisting pressure in two directions, such that the seal facilitates vacuum charging of the hydraulic system with an uncured resin (as will become apparent below) to prevent compressible air being trapped in the system and to prevent the ingress of fuel or contaminants during the service life of the cylinder array. However, it is possible to for the seal 20 to be a single acting seal; that is a seal which resists pressure in one direction only, such that a positive pressure may be applied in the chamber 17 to urge an upper end of the piston 3 from the cylinder 4.

The seal 20 of each piston 3 locates and mounts in a circumferentially extending recess 22 formed in the side wall 15 of each piston 3. It is envisaged that the seal 20 may be a high pressure hydraulic oil seal, an o-ring, or may utilise a ‘bellows’ arrangement, all of which facilitate the containment of a hydraulic fluid. Alternatively, it will be appreciated that the seal may be formed in a circumferentially extending recess (not shown) formed in the side wall 7 of the cylinder 4.

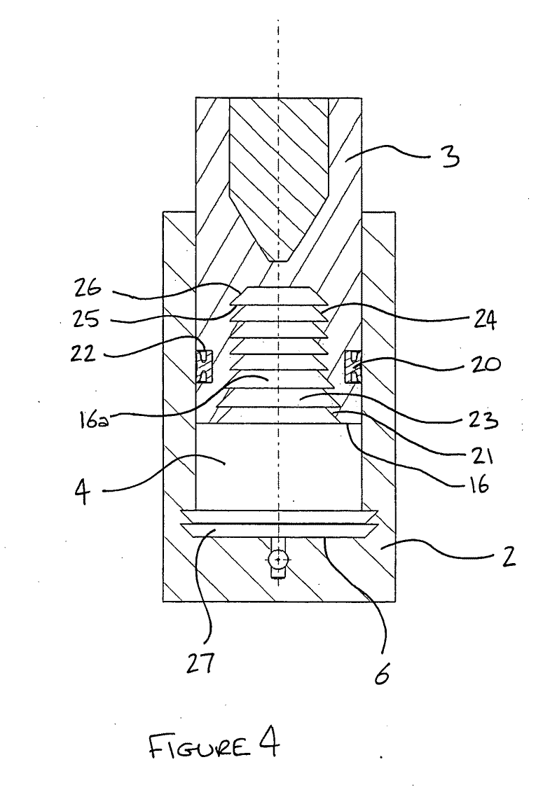

Referring to FIG. 4, a shear resisting means 23 is formed in each piston 3 so that, when the piston 3 is engaged or mated with a surface of the corresponding second component and resin in the chamber 17 and hollow 16a is cured (as will be explained below), each piston 3 is restricted from shearing relative to said cured resin, and being pulled out of its respective cylinder 4. The shear resisting means 23 is formed in a side wall 21 of each hollow 16a formed in the base 16 of each piston 3, and extends therealong, so that the uncured resin which is injected into the cavity 17 flows into the shear resisting means 23, as will become apparent hereinafter.

The shear resisting means 23 comprises a plurality of grooves 24 which circumferentially extend around the side wall 21 each hollow 16a formed in the base 16 of each piston 3. Each groove 24 has a transverse face 25 extending transversely from the hollow side wall 21 and an inclined face 26 extending from the hollow side wall 21 which is inclined to meet the transverse face 25 at the foot of said groove 24. It will be understood that the shear resisting means 23 is not limited to the above arrangement and that any arrangement of grooves or recesses may be used to resist shearing of the piston 3 relative to a cured resin in a solid state disposed in the chamber 17, as will become apparent hereinafter. In such an alternative arrangement, it will be appreciated that, in order to resist shearing of the piston 3 relative to the cured resin disposed therein, the structure will have at least one surface that extends at an angle to the hollow side wall 21 against which uncured resin can flow when it is injected into the chamber 17. For example, in an alternative arrangement a plurality of dimples (not shown) may be formed in the hollow side wall 15, or the grooves may have a curved or V-shaped cross-section, into which uncured resin is disposed.

A corresponding shear resisting means 27 is formed in the side wall 7 of each cylinder proximal to the cylinder base 6, and extends up the cylinder side wall 7 from the cylinder base 6 to a height below the level of travel of the piston seal 20. Therefore, the seal 20 does not contact the shear resisting means 27 formed in the side wall 7 of each cylinder 4 and affect the sealing action of said piston seal 20. It will be understood that such a corresponding shear resisting means 27 has a similar arrangement to the shear resisting means 23 formed in the side wall 15 of each piston 3, and so no further description will be given herein. The shear resisting means 27 is formed in the side wall 7 of each cylinder so that the piston 3 and cured resin disposed in the chamber 17 is restricted from shearing relative to the side wall 7 of the cylinder 4, and being pulled out of its respective cylinder 4, when the piston 3 in said cylinder 4 is engaged or mated with a surface of a corresponding component and resin in the chamber 17 and hollow 16a is cured (as will be explained below).

Although shear resisting means 23,27 formed in both the piston 3 and cylinder 4 are shown in FIG. 4 and described above, it will be appreciated that in an alternative arrangement a shear resisting means may be formed in each piston only, in each cylinder only, or neither. An advantage of the shear resisting means 23,27 of the piston 3 and cylinder 4 respectively is that they prevent the piston from being pulled out of the housing 1 when resin in the chamber 17 has cured and prevent a vacuum being created in the chamber 17, and therefore aid in the prevention of dusting of said cured resin, as will become apparent hereinafter.

Each piston 3 in this embodiment is formed from a pre-cured carbon fibre composite, with a portion of the upper end 19 proximate the upper face 18 of the piston being uncured or ‘green’ carbon fibre composite, for reasons that will be become apparent hereinafter. It is envisaged that each piston is formed with an uncured end by means of a cold junction curing process, with the last 5 mm of the piston being left uncured until the piston 3 abuts and/or mates with an opposing surface of a corresponding component, as will be described below. However, in an alternative embodiment each piston may be formed from a metallic or plastic material, or each entire piston may be formed from a cured composite material.

A cylindrical recess 29 is formed in the upper face 18 of each piston 3 and extends therein to form a secondary cylinder which extends longitudinally along a central axis of the respective piston 3. The cylindrical recess 29 formed in each piston 3 has a truncated cone shaped recess base 30 and a recess side wall 32 extending therearound. A secondary piston 33 is slidably received in the cylindrical recess 29 of each piston 3. Each secondary piston 33 has a secondary piston side wall 34 which locates against, and slides relative to, the respective recess side wall 32 when the secondary piston 33 is received in the cylindrical recess 29, and a bottom face 35 which has truncated cone shape, and which corresponds to the recess base 30. A cavity 38 is defined between the secondary piston bottom face 35 and the recess base 30 when each secondary piston 33 is received in the cylindrical recess 29. Each secondary piston 33 also has a secondary piston top face 36, distal to its bottom face 35. The length of each secondary piston 33 substantially conforms to the depth of its corresponding cylindrical recess 29, so that when each secondary piston is fully received in its respective cylindrical recess 29, then the top face 36 of said secondary piston 33 is level with the upper face 18 of its respective piston 3.

A plurality of longitudinally extending gullies 37 are formed in each secondary piston side wall 34 which extend between its top face 36 and its bottom face 35 such that, when each secondary piston 33 is received in its corresponding cylindrical recess 29, then a number of fluid passageways are formed by the gullies 37 and corresponding portions of the recess side wall 32 between the cavity 38 and the upper face 18 of the piston 3.

It will be appreciated that longitudinally extending gullies may alternatively be formed in each recess side wall 32 such that fluid passageways between the cavity 38 and the upper face 18 of each piston 3 are formed by the gullies in the recess side wall 32 and the surface of the corresponding secondary piston side wall 34. Although in the exemplary embodiment a single secondary piston is disposed in a corresponding secondary cylinder in each piston 3, in an alternative embodiment two, three or four cylindrical recesses are formed in the main piston extending from an upper face thereof in which respective auxiliary pistons are received. In such a case, the plurality of secondary pistons are distributed symmetrically about the longitudinal central axis of the main piston 3.

Each secondary piston 33 is formed from a cured carbon fibre material, with an upper portion proximate to the top face 36 being uncured or ‘green’ carbon fibre composite, for reasons that will be become apparent hereinafter. It is envisaged that each secondary piston 33 is formed with an uncured end by means of a cold junction curing process, with the last 5 mm of each secondary piston being left uncured until the secondary piston 33 abuts and/or mates with an opposing surface of a corresponding component, as will be described below. However, in an alternative embodiment each secondary piston may be formed from a metallic plastic material, or each entire piston may be formed from a cured or uncured composite material.

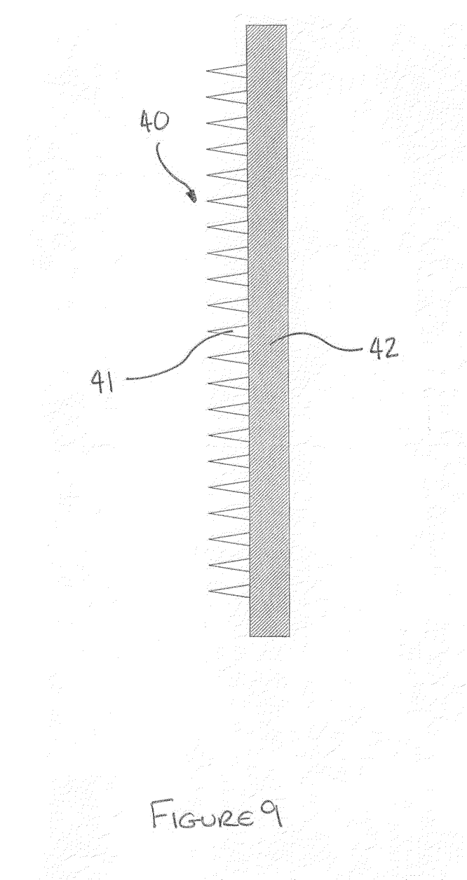

The opposing surface of a corresponding component against which the upper face 18 of the piston 3 is arranged to abut against and/or mate has a mating means 40 (refer to FIGS. 9 to 11) formed thereon, or mounted thereto to interact with a respective upper face 18 of the piston 3. It is also envisaged that said mating means will interact with the respective top face 36 of the secondary piston 33.

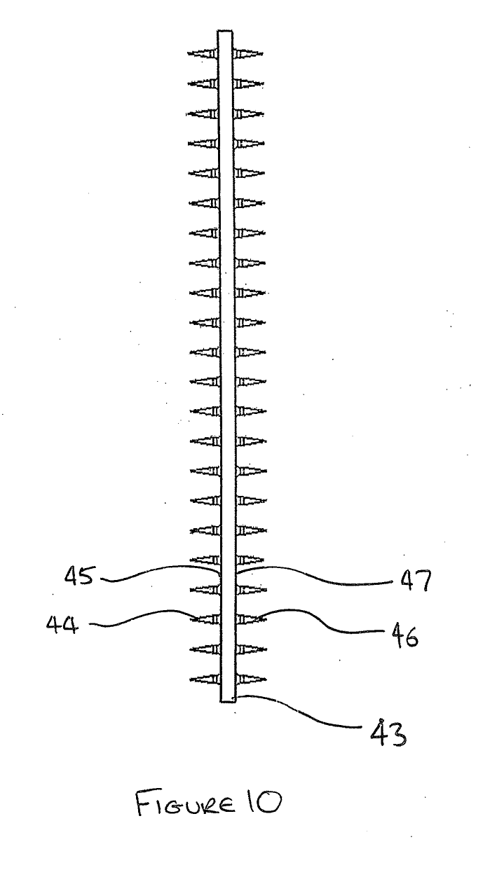

As can be seen from FIG. 9, the mating means 40 comprises an array of projections 41 which upstand from the opposing surface 42. The projections 41 are distributed evenly over a mating region against which it is intended that the upper face 18 of a piston 3 of the cylinder array 1 will abut. The projections 41 penetrate the upper end 19 of the piston 3 as will be explained hereinafter. Alternatively, referring to FIG. 10, it is envisaged that the mating means may comprise a plate 43 with a first array of projections 44 upstanding from a first face 45 of said plate and an opposing second array of projections 46 upstanding from an opposing second face 47 of the plate 43. The first array of projections 44 are penetrated into a surface of the component to which it is intended to mate the cylinder array 2, and mated therewith such that the plate 43 is fixedly mounted to the desired component. The second array of projections 44 then penetrate the upper end 19 of the piston 3 to locate and/or fix the component to another component mounted to the cylinder array 2, as will be explained hereinafter. The mating means is described in more detail in WO 2008/110835, which is hereby incorporated by reference.

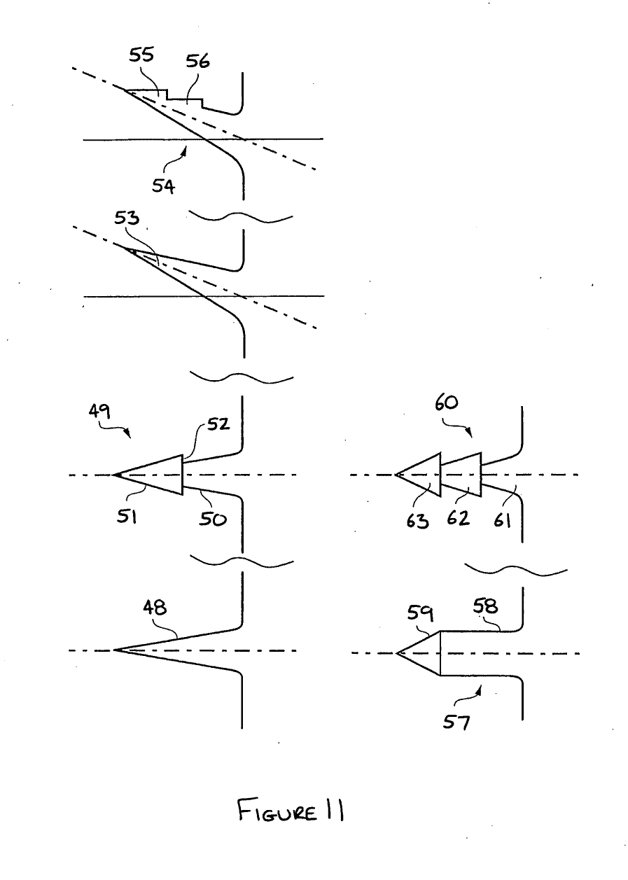

Various alternative projection profiles which may be used in the array of projections are shown in FIG. 11. A first projection 48 comprises a conical spike. A second projection 49 comprises a frustoconical base 50 and a conical tip 51 with an overhanging edge 52. A third projection 53 comprises a cone which leans at an angle to the vertical. A fourth projection 54 comprises a cone leaning at an angle to the vertical, with a pair of ridges 55,56 on its overhanging side. A fifth projection 57 comprises a cylindrical base 58 and a conical tip 59. A sixth projection 60 comprises a frustoconical base 61, a frustoconical part 62 with an overhanging edge 63, and a conical tip 64 with an overhanging edge. The aspect ratios of the projections are relatively high, and so give a firm mechanical engagement and a high surface area, as will become apparent hereinafter. Each of the projections discussed above have pointed tips to enable them to penetrate easily into the upper end 19 of the piston 3, and also the upper end of the secondary piston 33, as will become apparent hereinafter.

It is envisaged that one of the second, fourth or sixth projections 49,54,60 will be utilised to form the mating means because they each include a part with an overhanging edge which enhances the pull-off (tensile) strength of the mating means, as will become apparent hereinafter. However, the third or fourth projections, 53,54 may be used to improve properties in a particular loading direction.

Although one means of mating the upper face 18 of the piston 3 with an opposing surface of a corresponding component is described above, it will be appreciated that alternative mating means may be used. For example, an adhesive or resin ejected from the cavity 38, may be used to mate the piston upper face 18 with said surface. Furthermore, in an arrangement wherein the cylinder array urges a component into position, then no mating means may be utilised and the upper face 18 of the may simply abut against said opposing surface of said corresponding surface.

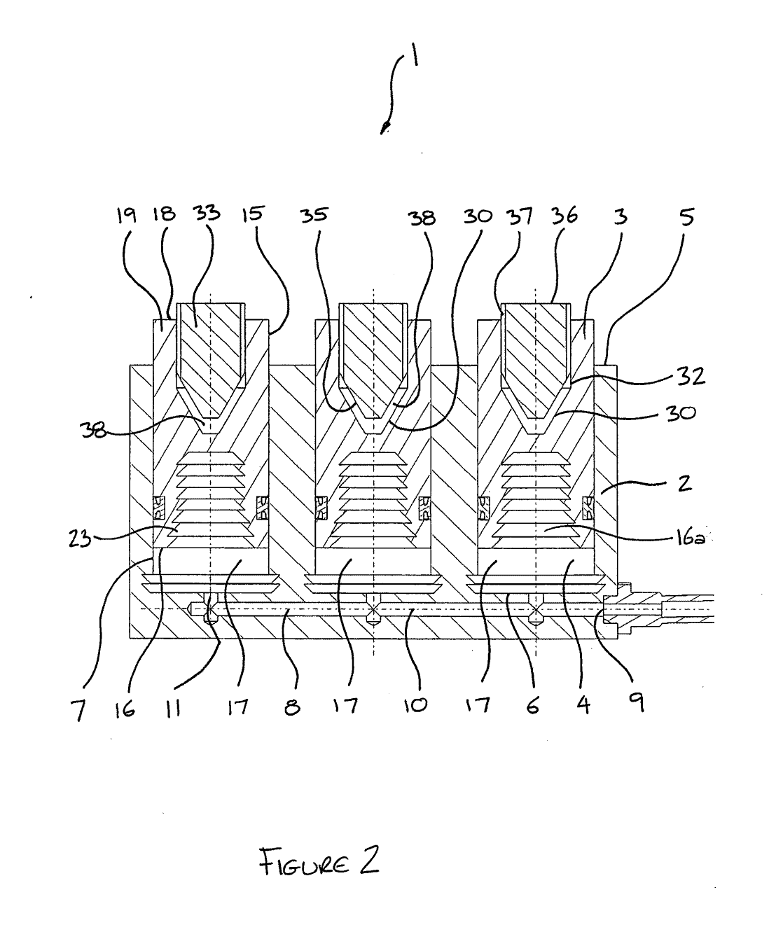

Operation of the cylinder array 1 will now be described with reference to the drawings, in particular FIGS. 2, 6 and 8.

Although the apparatus described below may be used for locating a first component with respect to a second component and/or for mating said first component to said second component in many technical fields, it is envisaged that the cylinder array described herein is used in the aerospace field, and the below operation will be described with reference to the locating and/or fixing of components to form an assembly for an aircraft. An advantage of using such an arrangement in the aeronautical field is that such an arrangement can be used to minimise the use of conventional fixings and corresponding pre-formed holes in the components.

The main housing 2 of the cylinder array 1 is fixedly mounted to a first component by the mounting points (not shown). This first component is intended to locate and/or mate with a second component, as will be explained hereinafter. In this exemplary embodiment, the first component is fixedly mounted to a side wall of the main housing, although in an alternative embodiment the first component may be fixedly mounted to a bottom wall, or in any other arrangement. Alternatively, the main housing 2 may be integrally is formed with the first component. A plurality of cylinder arrays 1 may be fixedly mounted to the first component so that the second component, or multiple second components, are fixedly located relative to the first component upon operation of the cylinder arrays.

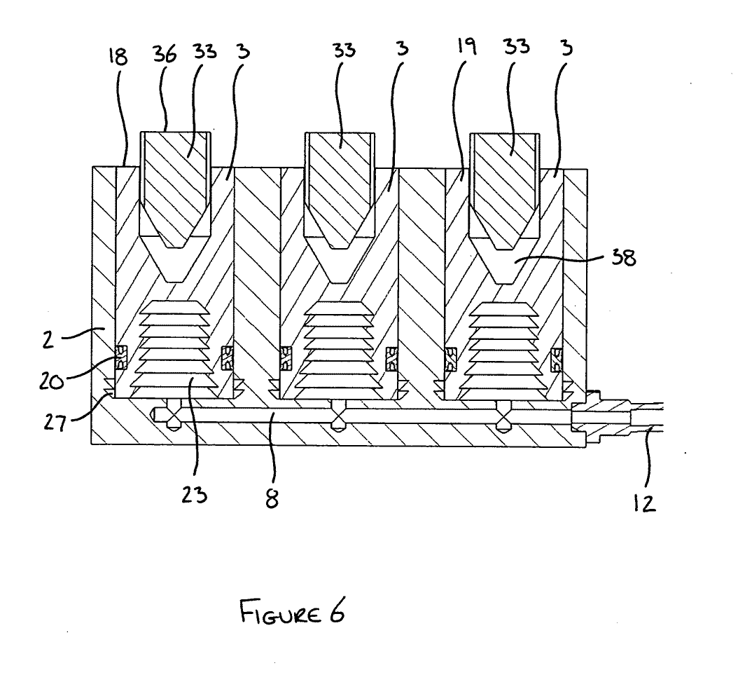

A predetermined volume of resin (not shown) is inserted into each secondary cylinder 29 formed in each piston 3. The secondary pistons 33 are then each inserted into their corresponding secondary cylinder 29 in each piston 3 such that the resin is disposed in the cavities 38 defined in the secondary cylinders 29. The resin in the cavity 38 is in an initial uncured fluid state, such that it is able to flow along the channels formed by the gullies and recess side wall to the upper end 19 of each piston 3 when the secondary piston 33 is urged into its respective secondary cylinder 32, as will be explained in detail below. The upper end of the secondary piston proximate the top face 36 thereof extends from the secondary cylinder 29, above the upper face 18 of the corresponding piston 3 (as shown in FIGS. 5 and 6).

Each piston 3 is then inserted into a corresponding cylinder 4 in the main housing 2 and slid thereinto until the upper face 18 is level with the top face 5 of the main housing 2. Each piston side wall 15 locates against the respective cylinder side wall 7 and the seal 20 extending circumferentially around the piston side wall 15 seals against said cylinder side wall 7 to form a fluid seal.

The inlet pipe 12 is then connected to the inlet 9 by the threaded section 14 to form a fluid passageway from a resin supplying pump (not shown), via the manifold 8 of the cylinder array 1, to each cylinder 4. The manifold 8 ensures that each cylinder 4 is in fluid communication with the inlet 9 and each other so that the same pressure is imparted on each piston 3 in each cylinder 4 when uncured resin is injected into the housing 2, as will become apparent hereinafter.

To locate the first component relative to the second component, the said components are disposed and held relative to each other in a spaced arrangement. The second component may be in its final desired position or orientation so that, when the pistons are activated and urged towards and against the second component then said first component is fixedly mounted to the second component, or may be positioned so that, when the pistons are activated and urged towards and against the second component, then the second component is urged to locate into its desired position by the force of the piston acting on said second component. The cylinder array may be used for driving, clamping, locking or shimming an aeronautical component relative to another aeronautical component.

The hydraulic system, comprising the inlet 9, manifold 8 and plurality of chambers 17 is then vacuum charged by drawing the air from the hydraulic system through the inlet pipe 12 to create a vacuum therein. In the present embodiment, the seal 20 is a double acting seal so that a vacuum may be formed in the hydraulic system, and the pistons 3 are fully withdrawn in their respective cylinders 4 so that they are in their initial retracted position, as shown in FIGS. 5 and 6. The uncured resin is then injected through the inlet pipe 12 into the cylinder array 1 such that it flows along the manifold into each cylinder 4. Due to the initial vacuum charging of the hydraulic system, the trapping of compressible air is prevented in the hydraulic system. The uncured resin injected into each cylinder 4 then fills the hollow 16a formed in each piston 3 and extends into the shear resisting means 23,27. As the uncured resin continues to be injected into each cylinder 4 through the manifold 8, each piston is urged to slide in its respective cylinder 4 by the resin in each chamber 17 acting on the piston base 16 and in the hollow 16a, to drive the upper end 19 of each piston 3 out of its respective cylinder 4. The seal 20 prevents resin from flowing between the side wall 15 of the piston 3 and the sidewall 7 of the cylinder 4.

As the resin is injected into each chamber 17, the upper end 19 of each piston 3 is urged to slide out of its respective cylinder 4 into an intermediate position as shown in FIG. 2. Each piston continues to slide out of its respective cylinder 4 until the top face 36 of each secondary piston 33 which extends from the upper end 19 of each piston 3 abuts the mating means 40 (refer to FIG. 9) extending from a surface of the second component. The resin is prevented from flowing between the side wall 7 of each cylinder 4 and the side wall 15 of each piston 3 by the seal 20 disposed in the circumferentially extending recess 22 formed around each piston 3 and locating against the side wall 7 of the corresponding cylinder 4.

The resin is further injected into the manifold 8 and so each piston 3 is further urged out of its respective cylinder 4. Each secondary piston 33 abuts against the mating means 40 extending from a surface of the second component and so is prevented from moving with their respective pistons and so the secondary piston is urged to slide into the cylindrical recess 29 from which each secondary piston 33 extends. As each secondary piston 33 is urged into its cylindrical recess 29, the bottom face 35 acts on the uncured resin disposed in the cavity 38 defined in each cylindrical recess 29 which is urged to flow along the gullies 37 formed in each secondary piston side wall 34 from the cavities 38 such that said resin flows to the upper end 19 of each piston, to aid the fixing of the upper end 19 of each piston to the surface of the second component, as will be explained hereinafter.

Each piston 3 is urged from its respective cylinder 4 by the pressure of the resin in the chamber 17 below each piston 3 acting on the piston base 16 until the upper face 18 at the upper end 19 of the piston 3 contacts the mating means 40 disposed on the surface of the second component. The secondary piston 33 associated with each piston 3 is then completely received in its cylindrical recess 29 so that the top face 36 of the secondary piston 33 is level with the upper face 18 of the piston.

When the secondary piston 33 is completely received in its respective cylindrical recess 29, the bottom face 35 of each secondary piston 33 abuts against the recess base 30 of the cylindrical recess and the resin in the cavity defined in said cylindrical recess is forced from said cavity and along the gullies formed in each secondary to flood the area of the upper face 18 of the respective piston 3 and the top face of the respective secondary piston 33.

In this case, the manifold linking each chamber ensures that the same hydraulic pressure is applied in each chamber, to each piston, so that the pistons slide in unison out of or into their respective cylinders and each piston applies the same pressure to the surface of the second component against which the upper end of the piston locates and mates thereagainst.

Once the upper end 19 of each piston contacts the mating means 40 extending from the surface of the second component the upper end of the piston is urged against said mating means 40. As the upper end 18 of each piston 3 and the top face 36 of each secondary piston 33 is urged against the mating means 40, the array of upstanding projections 41 of the mating means 40 penetrate the upper face 18 of the piston 3 and the top face 36 of the secondary piston 33, because the upper end 18 of each piston and upper portion of each secondary piston 33 are formed from an uncured carbon fibre composite and so the projections 41 are able to penetrate into said material and mate therewith. The resin ejected from the cavities 38 of the cylindrical recesses 29 fills the gaps between the mating means and the piston 3 and secondary piston 33.

As the pistons 33 are further urged against the second component, said component is either held in its desired position or urged into its desired position relative to the first component due to the pressure exerted by the pistons 3 on said second component. The pressure exerted by the hydraulic system acting in the manifold 8, each chamber 17 and therefore by each piston 3 on the second component causes the temperature to elevate in said regions as the pressure is increased and so the resin in the manifold 8, the resin ejected from the cavities 38 and the uncured upper ends of each piston 3 and secondary piston 33 is caused to cure or harden after the required pressure has been achieved and after a suitable period of time, therefore locking the cylinder array 1 in position.

As the resin in the manifold 8 and each chamber 17 cures, then the piston is fixedly mounted in position. Each piston 3 is prevented from sliding back into its respective cylinder 4 by the cured resin which fills the chamber 17 defined in each cylinder 4. Similarly, each piston 3 is prevented from being drawn from its respective cylinder 4 by the shear restricting structures 23,27 formed in both the hollow 16a in the piston 3 and the cylinder side wall 7, wherein cured resin is disposed in the plurality of grooves of the shear restricting structures 23, 27 so that the cured resin is restricted from shearing relative to the main housing 2 and the pistons are prevented from shearing relative to the cured resin.

The shear restricting structures 23,27 therefore prevents a vacuum being created in the chambers 17 of the cylinders 4 by each piston being urged to be drawn from its cylinder and so deterioration of the resin by dusting or the like is prevented.

As the upper ends of the pistons 3 and secondary pistons 33, and the resin ejected from the cavities 38 by the secondary pistons 33, cures the pistons are fixedly mounted to the second component by the mating means 40. In this case, the upstanding array of projections 41 of the mating means 40 penetrate the upper end 19 of each piston 3 and are then fixedly retained therein when said upper end 19 is cured. The mating means therefore restrict lateral movement of the second component relative to each piston 3 and therefore the cylinder array and first component. Similarly, the projections enhance the pull-off (tensile) strength of the joint between each piston and the second component because the projections 41 are disposed in the upper end 19 of each piston 3.

Furthermore, the resin ejected from the cavities 38 of the secondary pistons 33 acts as a secondary fixing means to fixedly mount the upper face 18 of each piston 3 to the surface of the second component. Said resin intersperses between the piston upper face 18 and the surface of the second component, inbetween the projections 41 of the mating means to secure the joint. In another embodiment, the resin ejected from the cavities 38 is an adhesive. It is further envisaged that, in a further embodiment, the piston upper face 18 locates against the surface of the second component without the mating means 40 and the resin ejected from the cavities 38 acts as an adhesive to fixedly mount each piston 3 to said surface.

Although in the above arrangement each piston has a secondary piston disposed therein, it will be appreciated that in an alternative embodiment each piston may not have a secondary piston disposed therein and the upper face of the piston may be planar without any recess being formed therein.

A further advantage of the resin setting in the hydraulic system and the upper ends of the pistons and secondary pistons being penetrated by the mating means is that the resin takes up manufacturing tolerances and defects. This provides a very stable arrangement when the resin is cured as the resin is able to fill any defects or cavities, and prevent air pockets, and so restrict stress concentration points and weaknesses.

It is envisaged that, in an embodiment wherein the pressure exerted by the hydraulic system on each piston is insufficient to cause the resin in the hydraulic system, the resin ejected from the cavities 38 and the upper ends of each piston 3 and secondary piston 33 to cure, heating means (not shown) are disposed on and/or in the main housing 2 of the cylinder array 2. It is envisaged that the heating means are activated once the pistons have been urged against the second component by the resin in the hydraulic system and the second component urged and/or located in position with respect to the first component to which the cylinder array 1 is fixedly mounted. The heating means heats the uncured resin and uncured upper ends of the pistons 3 and secondary pistons 33 to cause said resin and carbon fibre composite to cure and fix the pistons 3 in position, such that the first and second components are fixedly located with respect to each other. In one embodiment it is envisaged that the heating means are bullet heaters which are removably disposed in heater bores (not shown) formed in the main housing. Once the bullet heaters have been operated, and the resin and carbon fibre composite cured, then the bullet heaters are removed from the main housing 2. An advantage of such removable heaters is that it minimises the weight of the cylinder arrays, which is particularly important in an aerospace environment.

It will be appreciated that each piston may extend from the main housing by differing amounts once the pistons have been activated and urged against the surface of the second component dependent on the tolerances of the surface and the desired alignment of the second component, as shown in FIG. 7. However, the pressure exerted by each piston on the piston wall will be the same due to the fluid connection between each chamber associated with each piston so that the resin disposed in the hydraulic system exerts the same force on each piston base 16.

Once the resin and upper ends of the pistons have cured and the cylinder array is set in position so that the first and second components are fixedly located with respect to each other in their desired, predetermined positions, and the inlet pipe 12 can be removed from the cylinder array 1. The joint and fixing is then formed.

Although in the above embodiment only one cylinder array is shown for fixedly locating and/or mating components relative to each other, it will be appreciated that the invention is not limited thereto and that in an alternative arrangement a plurality of cylinder arrays may be mounted to a first component and one or more second components disposed relative thereto so that, when the pistons are activated each piston locates and/or mates with the or one of the second components.

An advantage of the present invention is that each piston acts on a small surface area and is capable of applying a high pressure on a component against which the mating surface of each piston locates and mates thereagainst.

In such an arrangement without secondary pistons, the upper end of the piston may be pre-impregnated with an epoxy resin which, when the temperature around the joint increases, either due to the pressure applied or the heating means then the epoxy resin matrix melts prior to curing and flows into intimate contact with the projections and so the projections mechanically engage with the matrix, whilst also increasing the surface area of the bond.

Locating relates to the moving of one component relative to another component and/or the positioning of said one component with respect to said another component in a desired position or location such that said components are fixedly mounted/mated with respect to each other.

Although in the above exemplary embodiments a mating means is disposed on the surface of the second component to which each piston abuts and/or locates, it will be appreciated that the upper end of each piston may locate on a surface of the second component without any mating means and urge or locate thereagainst, or in an alternative embodiment the mating means may be disposed on the upper end of the piston and impregnate the surface of the second component.

Although in the above exemplary embodiments, each cylinder 4 fluidly communicates with the inlet pipe 12 or a similar inlet means through the manifold 8 formed in the main housing 2, it will be understood that in an alternative arrangement, each orifice 9 may extend from its respective cylinder 4 to an outer face of the main housing 2 and fluidly communicate with inlet pipes or inlet means.

Although in the above embodiment the main housing 2 is described and shown having three cylinders 4 so that the cylinder array 1 has three pistons 3 disposed therein, it will be understood that the invention is not limited thereto and that the cylinder array 1 may have a single cylinder formed therein. Alternatively, the cylinder array may have a plurality of cylinders, for example two, four or five cylinders, with a respective piston disposed in each cylinder.

In the above described embodiments the cylinder array is arranged with each piston extending in the same plane, so that they extend in the same direction to abut against and apply a force to the second component in the same direction. However, it is envisaged that the cylinder array may be formed so that the pistons extend from the main housing on different planes and in different directions. For example, in one embodiment a first piston may extend from the main housing of the cylinder array along an axis which extends at a right angle to an axis of a second piston so that the first component can be located relative to a second component in two transverse directions. Alternatively, it will be envisaged that one or more pistons may be arranged to extend from the main housing along axes aligned at an angle to one or more other pistons, or arranged to extend in an opposing direction so that the cylinder array may be used to fixedly mount a second component with respect to a first component.

It will also be appreciated that in one embodiment a cylinder array has three sets of opposing pistons extending in each of three perpendicular directions so that pressure is applied uniformly in each direction. Therefore, a second component is located relative to a first component having a cylinder array, with the cylinder array received in the second component. The cylinder array is then actuated so that each set of opposing pistons are urged to extend out of the housing to act against the second component and so fixedly mount the second component with respect to the first component.

It will be appreciated that the foregoing description is given by way of example only and that modifications may be made to the present invention without departing from the scope of the appended claims.

1. An apparatus for fixedly locating a first aerospace component relative to a second aerospace component comprising a housing mountable on a first component with a cylinder formed in said housing, and a piston slidably received in said cylinder, wherein a first end of the piston is extendible from the housing such that, when a hardenable hydraulic fluid is injected into the cylinder to act on a second end of said piston, said first end of the piston is urged to slide away from the housing and into abutment with a second component to locate said second component, and said second component is fixedly located in a desired position relative to said first component when the hydraulic fluid hardens.

2. An apparatus according to claim 1, wherein a plurality of cylinders are formed in the housing and each cylinder slidably receives a piston therein.

3. An apparatus according to claim 2, wherein the plurality of pistons are configured to slide in the same direction from the housing along parallel longitudinal axes.

4. An apparatus according to claim 1, wherein at least one piston is configured to slide from the housing along a longitudinal axis extending at an incline to another piston.

5. An apparatus according to claim 2, wherein at least one piston is configured to slide from the housing along a longitudinal axis extending transversely to another piston.

6. An apparatus according to claim 2, further comprising a manifold fluidly connecting each of the plurality of cylinders to each other, such that the same hydraulic pressure is applied in each cylinder, to each piston.

7. An apparatus according to claim 6, further comprising a fluid inlet formed in the housing which is in fluid communication with the manifold, so that a fluid is injected into each cylinder when said fluid is injected through the inlet.

8. An apparatus according to claim 1, further comprising a seal circumferentially extending around the piston which seals against the sidewall of the cylinder.

9. An apparatus according to claim 8, wherein the seal is a double acting seal.

10. An apparatus according to claim 1, wherein the piston is a primary piston which is slidably received in the cylinder which is a primary cylinder, and the apparatus further comprises a secondary cylinder formed in said first end of the primary piston and a secondary piston which is slidably received in the secondary cylinder to extend from said first end.

11. An apparatus according to claim 10 wherein a cavity is defined between the secondary cylinder and the secondary piston to receive a resin or adhesive and a passageway extends from the cavity to said first end of the primary piston, such that when the secondary piston is urged to slide into the secondary cylinder, the resin or adhesive is urged to flow to said first end of the primary cylinder.

12. An apparatus according to claim 11, wherein the passageway is a gulley formed in a side wall of the secondary cylinder.

13. An apparatus according to claim 12, wherein a plurality of longitudinally extending gullies are formed in the side wall of the secondary cylinder.

14. An apparatus according to claim 1, wherein a shear resisting means is formed in the piston to receive a hydraulic fluid injected into the cylinder, such that when the hydraulic fluid hardens into a solid state, the piston is restricted from shearing relative to said hydraulic fluid hardened into a solid state.

15. An apparatus according to claim 14, wherein a hollow is formed in the second end of the piston and the shear resisting means is formed in a side wall of the hollow.

16. An apparatus according to claim 15, wherein the shear resisting means comprises a circumferentially extending groove formed in the side wall of the hollow.

17. An apparatus according to claim 1, wherein a shear resisting means is formed in the side wall of the cylinder to receive a hydraulic fluid injected into the cylinder, such that when the hydraulic fluid hardens into a solid state, the hydraulic fluid hardened into a solid state is restricted from shearing relative to the housing.

18. An apparatus according to claim 17, wherein the shear resisting means comprises a circumferentially extending groove formed in the side wall of the cylinder.

19. An apparatus according to claim 1, further comprising a hydraulic fluid which is injected into the cylinder to act on the second end of the piston slidably received in said cylinder and urge a first end of said piston is urged to slide away from the housing.

20. An apparatus according to claim 19, wherein the fluid is configured to harden in the cylinder such that the piston is restricted from sliding back into the cylinder.

21. An apparatus according to claim 20, wherein the fluid is a curable resin.

22. An apparatus according to claim 21, wherein reinforcing materials are suspended in the curable resin.

23. An apparatus according to claim 1, wherein the first end of the piston is formed from uncured carbon fibre and is configured to be penetrated by a mating means extending from said second component to fixedly mount said first end of the piston to said second component.

24. A joint comprising a first component and a second component which are fixedly located to each other by an apparatus according to claim 19.

25. A joint according to claim 24, further comprising a mating means extending from said second first component, and penetrating into the first end of the second component.

26. A method of fixedly locating a first aerospace component relative to a second aerospace component with an apparatus comprising a housing with a cylinder formed in said housing, and a piston slidably received in said cylinder, wherein a first end of the piston is extendible from the housing, the method including the steps of:
a) mounting the housing to a first component,
b) injecting a hardenable hydraulic fluid into the cylinder to act on a second end of the piston disposed in said cylinder, such that said first end of said piston is urged to slide away from the housing and into abutment with a second component to locate said second component, and
c) hardening said hydraulic fluid such that said second component is fixedly located in a desired position relative to said first component.

27. A method according to claim 26, wherein the hardenable hydraulic fluid is a curable resin, and the method further includes the steps of removably mounting a heating means to the housing and operating said heating means to heat and cure the resin.

28. An assembly of components prepared by the method of claim 26.
